(19) United States
(12) Patent Application Publication
(10) Pub. No.: US 2025/0111492 A1
(43) Pub. Date: Apr. 3, 2025

(54) MANAGEMENT APPARATUS, MANAGEMENT METHOD, MANAGEMENT SYSTEM, RADIOLOGY INFORMATION SYSTEM, DYNAMIC ANALYSIS APPARATUS, AND PROGRAM

(71) Applicant: Konica Minolta, Inc., Tokyo (JP)

(72) Inventor: Tatsuya TAKAGI, Tokyo (JP)

(21) Appl. No.: 18/897,231

(22) Filed: Sep. 26, 2024

(30) Foreign Application Priority Data
Sep. 28, 2023 (JP) 2023-167707

(51) Int. Cl. G06T 7/00; G06F 16/51

(52) U.S. Cl. CPC G06T 7/0002; G06F 16/51

(57) ABSTRACT

Provided is a management apparatus that includes: an image DB in which an image is stored; an image management information DB in which an imaging apparatus having imaged each of a plurality of the images is recorded; quality control information DB which stores whether imaging for the imaging apparatus to perform dynamic analysis processing is possible; and a hardware processor that determines whether the dynamic analysis processing is executable on the plurality of images stored in the image DB.

### CROSS REFERENCE TO RELATED APPLICATIONS

The entire disclosure of Japanese Patent Application No. 2023-167707, filed on Sep. 28, 2023 is incorporated herein by reference in its entirety.

### BACKGROUND

### Technological Field

The present disclosure relates to a management apparatus, a management method, a management system, a radiology information system, a dynamic analysis apparatus, and a program.

### Description of Related Art

In imaging using radiation such as X-rays, imaging requests are registered in radiology information systems called RIS (Radiology Information Systems). A clinical laboratory technician sets imaging conditions and the like based on an imaging request registered in an RIS, and X-ray imaging is performed by an imaging apparatus.

In recent years, it is known that image analysis is performed on dynamic images acquired by X-ray imaging to visualize and quantify information on specific diseases.

For example, Japanese Patent Publication Laid-Open No. 2022-11259 discloses a quality control method for efficiently performing quality control of dynamic imaging by outputting information on qualities of dynamic images obtained by imaging for generating dynamic images (hereinafter referred to as “dynamic imaging”) and information on functions of a radiography apparatus used for the dynamic imaging.

However, studies on dynamic imaging in medical sites have been revealing the qualities of images necessary for dynamic analysis processing for examining a certain disease, that is, a processing mode. To image an image with a necessary quality, a dynamic imaging apparatus needs to have a predetermined imaging capability (e.g., resolution). That is, in order to perform each dynamic analysis processing, it is necessary to use a dynamic image apparatus having a predetermined imaging capability. When a dynamic image imaged using an apparatus that cannot obtain an image with a resolution necessary for imaging is analyzed, an appropriate dynamic analysis result may not be obtained. Such analysis is wasteful and unnecessarily increases the load on the apparatus that performs the dynamic analysis processing. In a case where what type of dynamic analysis processing is to be performed has not been determined at the time of dynamic imaging, but dynamic analysis processing is performed on a dynamic image imaged thereafter, it is wasteful to perform dynamic analysis processing by which an appropriate dynamic analysis result cannot be obtained.

### SUMMARY

An object of the present disclosure is to stop wasteful dynamic analysis processing and reduce the load on a dynamic analysis processing apparatus by determining whether dynamic analysis processing on an imaged image is possible.

A management apparatus according to an embodiment of the present disclosure includes: an image DB in which an image is stored; an image management information DB in which an imaging apparatus having imaged each of a plurality of the images is recorded; and a determiner that determines, based on quality control information storing whether imaging for the imaging apparatus to perform dynamic analysis processing is possible, whether the dynamic analysis processing is executable on the plurality of images stored in the image DB.

A radiology information system according to an embodiment of the present disclosure includes a management apparatus that includes: an image DB in which an image is stored; an image management information DB in which an imaging apparatus having imaged each of a plurality of the images is recorded; and a determiner that determines, based on quality control information storing whether imaging for the imaging apparatus to perform dynamic analysis processing is possible, whether the dynamic analysis processing is executable on the plurality of images stored in the image DB.

A dynamic analysis apparatus according to an embodiment of the present disclosure includes a management apparatus that includes: an image DB in which an image is stored; an image management information DB in which an imaging apparatus having imaged each of a plurality of the images is recorded; and a determiner that determines, based on quality control information storing whether imaging for the imaging apparatus to perform dynamic analysis processing is possible, whether the dynamic analysis processing is executable on the plurality of images stored in the image DB.

A management method according to an embodiment of the present disclosure determines whether dynamic analysis processing is executable on an image having been inputted, based on: information for identifying the image; image management information in which an imaging apparatus having imaged each of a plurality of the images is recorded; and quality control information that stores whether imaging for the imaging apparatus to perform the dynamic analysis processing is possible.

A program according to an embodiment of the present disclosure causes a computer to execute: acquiring information for identifying an image; acquiring which imaging apparatus has imaged the image identified by the information for identifying the image, where the imaging apparatus is an imaging apparatus or one of a plurality of imaging apparatuses; acquiring quality control information that indicates whether the imaging apparatus or each of the plurality of imaging apparatuses is capable of obtaining an image with a quality necessary for performing dynamic analysis processing; and determining whether each of a plurality of pieces of the dynamic analysis processing is possible on the image identified by the information for identifying the image.

A management system according to an embodiment of the present disclosure stores whether imaging for an imaging apparatus or each of a plurality of imaging apparatuses to perform dynamic analysis processing is possible, identifies an image that is stored, identifies the imaging apparatus or one of the plurality of imaging apparatuses that has imaged each of a plurality of the images, and determines whether the dynamic analysis processing is executable on the plurality of images having been stored.

Note that, these generic or specific aspects may be implemented as a system, an apparatus, a method, an integrated circuit, a computer program, or a recording medium, or any selective combination of a system, an apparatus, a method, an integrated circuit, a computer program, and a recording medium.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration of an RIS;

FIG. 2 is a diagram illustrating a configuration of a management apparatus;

FIG. 3 is a diagram illustrating an example of image management information stored in an image management information DB;

FIG. 4 is a diagram illustrating an example of quality control information stored in a quality control information DB;

FIG. 5 is a diagram illustrating a display example in a case where a requested dynamic analysis processing request can be executed;

FIG. 6 is a diagram illustrating a display example in a case where a requested dynamic analysis processing request cannot be executed;

FIG. 7 is a diagram illustrating an output example in a case where a doctor selects the image management number 01001;

FIG. 8 is a diagram illustrating determination results of whether a plurality of pieces of dynamic analysis processing can be performed on images with image management numbers;

FIG. 9 is a diagram illustrating determination results as to whether the plurality of pieces of dynamic analysis processing can be performed on images imaged for patients in the past;

FIG. 10 is a diagram illustrating a display example of whether each analysis apparatus can perform dynamic analysis processing on images;

FIG. 11 is a diagram illustrating a flowchart of processing performed by a determination section;

FIG. 12 is a diagram illustrating a flowchart of another processing performed by the determination section; and

FIG. 13 is a diagram illustrating a hardware configuration of a management apparatus.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present disclosure will be described in detail with reference to the accompanying drawings as appropriate.

### <System Configuration>

First, a schematic configuration of a management apparatus according to an embodiment of the present disclosure will be described.

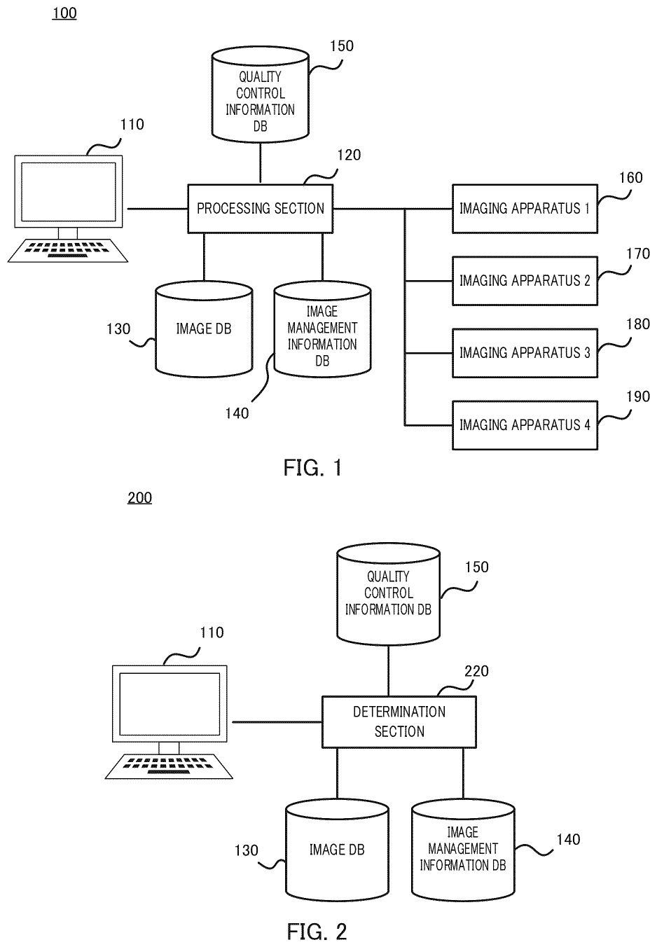

FIG. 1 is a diagram illustrating a configuration of RIS 100.

For example, in a case where four imaging apparatuses are present in a hospital, RIS 100 is constituted by input/output section 110, processing section 120, image database (DB) 130, image management information DB 140, quality control information DB 150, and imaging apparatuses 1 to 4. The number of imaging apparatuses is not limited to four.

A dynamic imaging request is inputted to input/output section 110 by, for example, a doctor.

Processing section 120 determines an imaging apparatus for processing an imaging request inputted by a doctor, and transfers the imaging request to the determined imaging apparatus. A technician of the imaging apparatus performs imaging based on the transferred imaging request.

In image DB 130, dynamic or static images imaged by imaging apparatuses determined by processing section 120 are accumulated. Only dynamic images may be stored in image DB 130, and static images may be stored in static image DB.

Image DB 130 may be, for example, a storage means such as a hard disk drive (HDD) or a solid state drive (SSD). Image DB 130 may be a storage means on a cloud.

Image management information DB 140 stores image management information on images accumulated in image DB 130. The image management information includes information on imaging apparatuses that have imaged dynamic or static images stored in image DB 130. The image management information may include information on an image type indicating whether the image is a dynamic image or a static image, a patient name, and imaging date and time. The image management information may include imaging conditions such as a frame rate.

Image management information DB 140 may be, for example, a storage means such as an HDD or an SSD. Image management information DB 140 may be a storage means on a cloud.

Quality control information DB 150 stores quality control information indicating whether an image with a quality necessary for an imaging apparatus to perform each dynamic analysis processing can be imaged.

Quality control information DB 150 may be, for example, a storage means such as an HDD or an SSD. Quality control information DB 150 may be a storage means on a cloud.

Image DB 130, image management information DB 140, and quality control information DB 150 may be constituted by one DB or two DBs. The image management information may be stored as an image management information file in image management information DB 140, or may be stored as status information of a dynamic or static image stored in image DB 130.

FIG. 2 is a diagram illustrating a configuration of management apparatus 200.

Management apparatus 200 is constituted by input/output section 110, image DB 130, image management information DB 140, quality control information DB 150, and determination section 220. Management apparatus 200 may be configured as a part of RIS 100. Management apparatus 200 may be configured as a part of a dynamic analysis apparatus.

A dynamic analysis processing request is inputted to input/output section 110 by a doctor. A dynamic analysis processing request may be inputted to RIS 100 by a doctor, and management apparatus 200 may acquire the dynamic analysis processing request from RIS 100. In addition, input/output section 110 outputs a determination result of determination section 220.

Determination section 220 determines, based on the dynamic analysis processing request inputted through input/output section 110, the images accumulated in image DB 130, image management information DB 140, and the quality control information stored in quality control information DB 150, whether the requested dynamic analysis processing can be performed on each image.

The dynamic analysis processing request includes information indicating the type of the dynamic analysis processing.

Determination section 220 may determine whether dynamic analysis processing can be performed on an image accumulated in image DB 130 after processing of determining what type of dynamic analysis processing is to be performed for the dynamic analysis process request acquired through input/output section 110 is executed. In a case where an imaging condition is included in the image management information, determination section 220 may determine whether each dynamic analysis process can be executed in consideration of the imaging condition.

Determination section 220 may be, for example, a computer such as a central processing unit (CPU). Determination section 220 may be a computer on a cloud. Determination section 220 may be present in an input/output terminal including input/output section 110 or may be present in an analysis apparatus.

Determination section 220 can determine whether dynamic analysis processing can be performed on an image accumulated in the image DB in response to a dynamic analysis processing request.

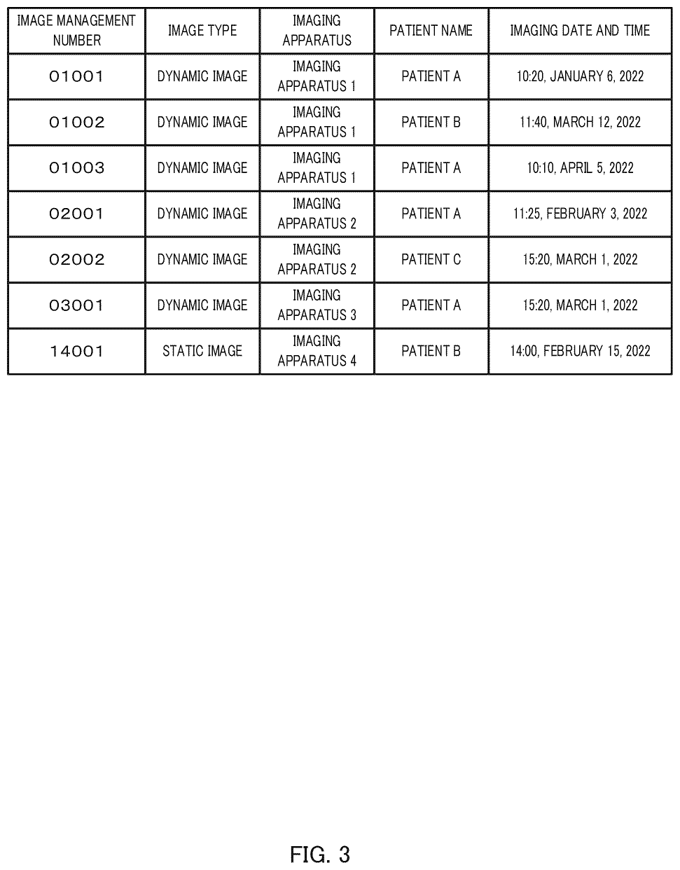

FIG. 3 is a diagram illustrating an example of image management information stored in image management information DB 140. The image management information exemplified in FIG. 3 includes image management numbers, image types, patient names, and imaging dates and times. Imaging conditions, which are conditions under which images have been imaged, may also be included therein.

FIG. 3 illustrates that the image with the management number 01001 is a dynamic image of patient A imaged at 10:20 on Jan. 6, 2022 by imaging apparatus 1, the image with the management number 01002 is a dynamic image of patient B imaged at 11:40 on Mar. 12, 2022 by imaging apparatus 1, the image with the management number 01003 is a dynamic image of patient A imaged at 10:10 on Apr. 5, 2022 by imaging apparatus 1, the image with the management number 02001 is a dynamic image of patient A imaged at 11:25 on Feb. 3, 2022 by imaging apparatus 2, the image with the management number 02002 is a dynamic image of patient C imaged at 15:20 on Mar. 1, 2022 by imaging apparatus 2, the image with the management number 03001 is a dynamic image of patient A imaged at 13:20 on May 13, 2022 by imaging apparatus 3, and the image with the management number 14001 is a static image of patient B imaged at 14:00 on Feb. 15, 2022 by imaging apparatus 4.

The management number is a unique number assigned to one dynamic imaging or static image imaging.

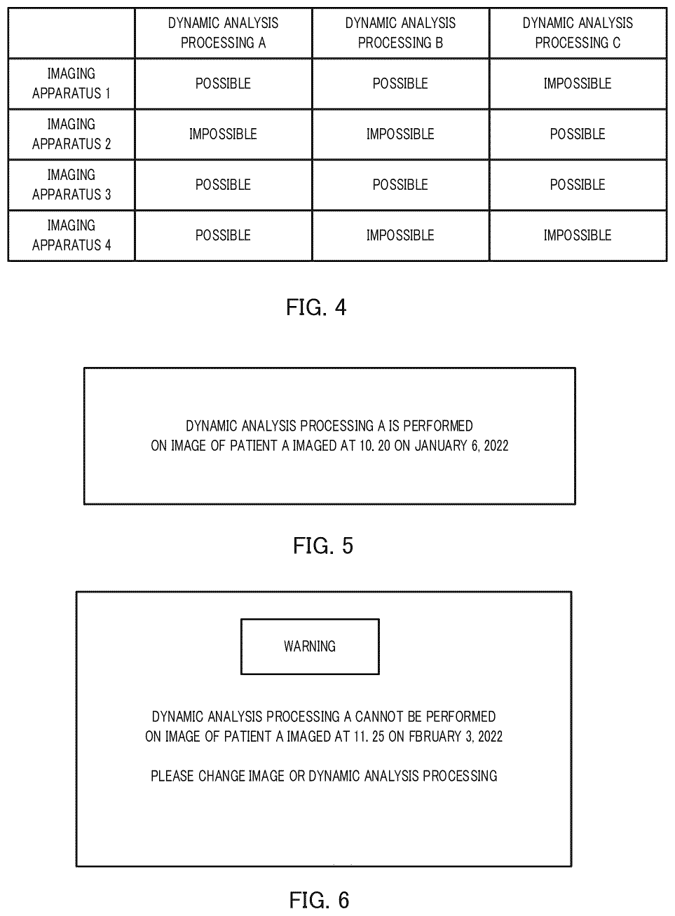

FIG. 4 is a diagram illustrating an example of quality control information stored in quality control information DB 150.

FIG. 4 illustrates that imaging apparatus 1 can image an image with a quality necessary for performing dynamic analysis processing A and dynamic analysis processing B, but cannot image an image with a quality necessary for performing dynamic analysis processing C; imaging apparatus 2 can image an image with a quality necessary for performing dynamic analysis processing C, but cannot image an image with a quality necessary for performing dynamic analysis processing A and dynamic analysis processing B; imaging apparatus 3 can image an image with a quality necessary for performing each of dynamic analysis processing A, dynamic analysis processing B, and dynamic analysis processing C; and imaging apparatus 4 can image an image with a quality necessary for performing dynamic analysis processing A, but cannot image an image with a quality necessary for performing dynamic analysis processing B and dynamic analysis processing C. The number of imaging apparatuses may not be four, and the types of analysis processing may not be three.

The quality control information may include information as to whether imaging allows each dynamic analysis processing to be performed according to the imaging conditions.

### Embodiment 1

Embodiment 1 indicates, for example, a case in which a management apparatus executes processing based on a dynamic analysis processing request from a doctor.

For example, in a case where a dynamic analysis processing request for “dynamic analysis processing A” has been made for the image with the management number 01001, determination section 220 understands, by referring to the image management information stored the image DB 130, that the image with the management number 01001 is a dynamic image imaged by imaging apparatus 1. Here, determination section 220 understands, by referring to the quality control information of FIG. 4 stored in quality control information DB 150, that imaging apparatus 1 is an imaging apparatus capable of imaging an image with a quality necessary for dynamic analysis processing A. Then, since it is understood that the image with the management number 01001 is an image with a quality necessary for performing dynamic analysis processing A, determination section 220 determines that dynamic analysis processing A can be performed on the image with the management number 01001. Accordingly, in response to an input of the dynamic analysis processing request, input/output section 110 may display “DYNAMIC ANALYSIS PROCESSING A IS PERFORMED ON IMAGE OF PATIENT A IMAGED AT 10. 20 ON Jan. 6, 2022” or the like.

FIG. 5 is a diagram illustrating a display example in a case where a requested dynamic analysis processing request can be executed.

In a case where a dynamic analysis processing request for “dynamic analysis processing A” has been made for the image with the management number 02001, on the other hand, determination section 220 understands, by referring to the image management information stored the image DB 130, that the image with the management number 02001 is a dynamic image imaged by imaging apparatus 2. Here, determination section 220 understands, by referring to the quality control information of FIG. 4 stored in quality control information DB 150, that imaging apparatus 2 is an imaging apparatus incapable of imaging an image with a quality necessary for dynamic analysis processing A. Then, since it is understood that the image with the management number 02001 is not an image with a quality necessary for performing dynamic analysis processing A, determination section 220 determines that dynamic analysis processing A cannot be performed on the image with the management number 02001. Accordingly, for example, in response to an input of the dynamic analysis processing request, input/output section 110 may display a warning “DYNAMIC ANALYSIS PROCESSING A CANNOT BE PERFORMED ON IMAGE OF PATIENT A IMAGED AT 11. 25 ON FBRUARY 3, 2022” or the like. In a case where determination section 220 determines that dynamic analysis processing for the dynamic analysis processing request is impossible, determination section 220 may request new dynamic imaging for performing the dynamic analysis processing determined as impossible.

FIG. 6 is a diagram illustrating a display example in a case where a requested dynamic analysis processing request cannot be executed.

In a case where a request for a list of images stored in image DB 130 is inputted through input/output section 110, determination section 220 may determine whether dynamic analysis processing on each image is possible.

When a doctor selects the image management number 01001 through input/output section 110, determination section 220 may determine whether each dynamic analysis processing is executable on the image with the selected image management number, and output the determination result to input/output section 110.

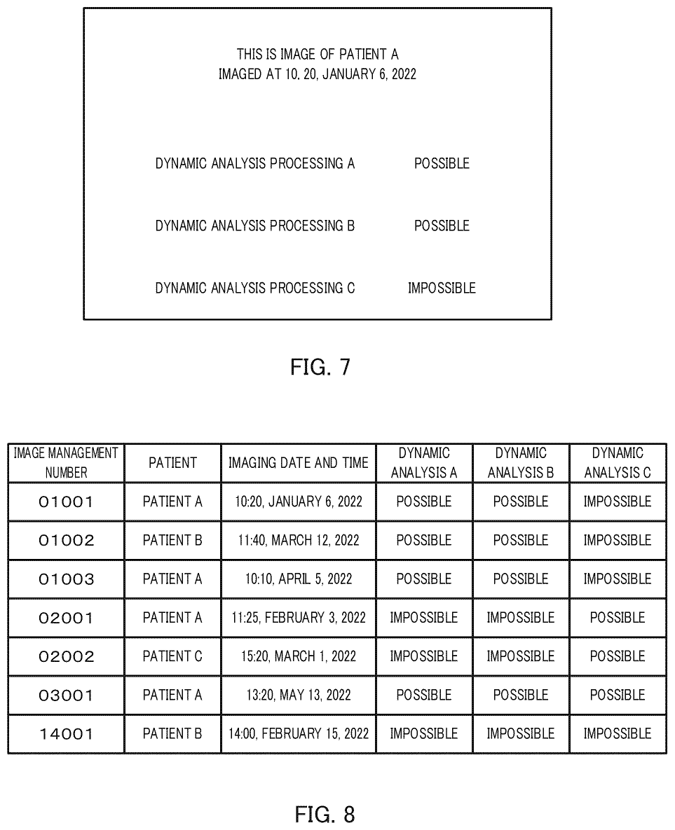

FIG. 7 is a diagram illustrating an output example in a case where a doctor selects the image management number 01001. By selecting the dynamic analysis processing indicated as “possible” in FIG. 7, a dynamic analysis processing request for the selected dynamic analysis processing on the image with the selected image management number may be made.

FIG. 8 is a diagram illustrating determination results of whether dynamic analysis processing A, dynamic analysis processing B, and dynamic analysis processing C can be performed on images with image management numbers stored in image DB 130. The display of FIG. 8 may be outputted at the request of a doctor. When an image management number and analysis processing are identified on the screen on which the display is outputted, a request for analysis processing on the image with the image management number may be made. For example, determination section 220 may request dynamic analysis processing A on the image with the image management number 01001 by a doctor selecting “possible” in the column of “analysis processing A” with the row of “image management number 01001”.

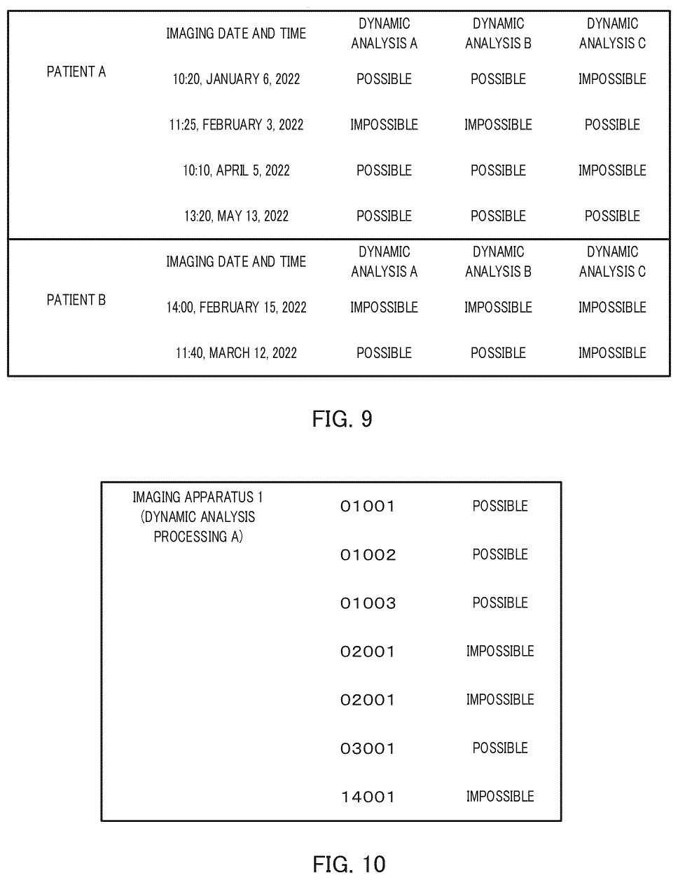

FIG. 9 is a diagram illustrating determination results as to whether the plurality of pieces of dynamic analysis processing can be performed on images imaged for patients in the past. For example, in a case where a doctor requests “past images of patients A and B” through input/output section 110, determination section 220 may output the results illustrated in FIG. 9 to input/output section 110. For patient A, images imaged at 10:20 on Jan. 6, 2022, at 11:25 on Feb. 3, 2022, at 10:10 on Apr. 5, 2022, and at 13:20 on May 13, 2022 are stored, and it is illustrated whether dynamic analysis processing A, dynamic analysis processing B, and dynamic analysis processing C can be performed on each image. When an image management number and analysis processing are identified on the screen on which the results are outputted, a request for analysis processing on the image with the image management number may be made. For example, when a doctor selects “possible” in the column of “dynamic analysis A” with the row of “10:20, Jan. 6, 2022”, determination section 220 may request dynamic analysis processing A on the image with the image management number 01001.

In a case where “impossible” is selected, a request for imaging in which the dynamic analysis processing can be performed on the patient may be made. For example, in a case where a doctor selects “impossible” in “dynamic analysis processing C” for the image of patient B at 11:40 on Mar. 12, 2022, determination section 220 may request dynamic imaging in which dynamic analysis processing C can be performed for patient B.

Images on which each dynamic analysis processing can be performed may be outputted for each patient.

With this output, it is outputted whether each dynamic analysis processing can be performed on the images of each patient, and thus, it is possible to perform diagnosis in consideration of the history.

FIG. 10 is a diagram illustrating a list of images on which dynamic analysis apparatus 1, which executes dynamic analysis processing A, can execute dynamic analysis processing A. For example, in a case where dynamic analysis apparatuses supporting each dynamic analysis processing are included, it is possible to determine on which image each dynamic analysis apparatus can execute dynamic analysis processing or not. Since a dynamic analysis apparatus that performs dynamic analysis processing understands the dynamic analysis processing that can be performed by itself, the dynamic analysis apparatus may provide the quality control information. In this case, quality control information DB 150 may be omitted.

With this output, in a case where dynamic analysis processing requests are accumulated in the RIS and the dynamic analysis apparatus side selects and executes an accumulated dynamic analysis processing requests, it is possible to select only an image for which dynamic analysis processing is possible and the dynamic analysis processing can be executed.

### <Flowchart>

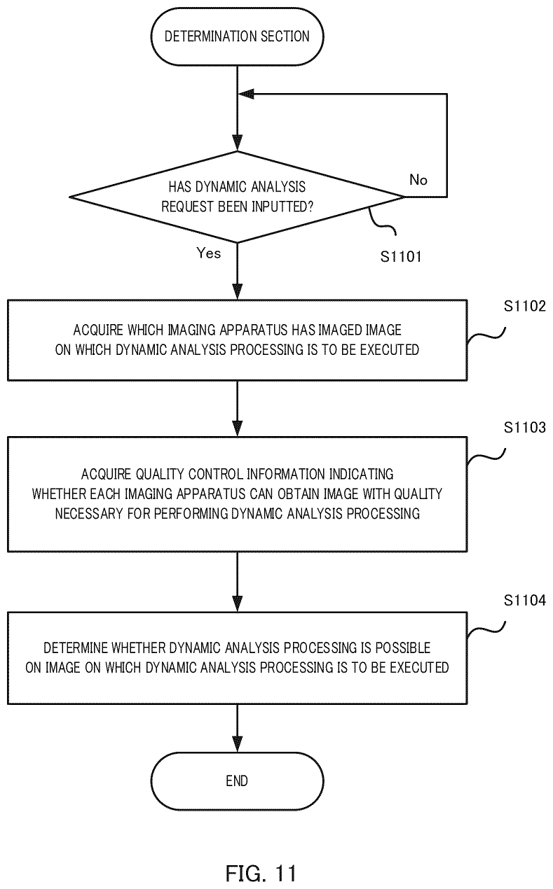

FIG. 11 is a diagram illustrating a flowchart of processing performed by determination section 220.

Determination section 220 determines whether a dynamic analysis processing request has been inputted (step S1101).

In a case where a dynamic analysis processing request has not been inputted, determination section 220 causes the flow to return to step S1101 and waits for an input of an imaging request.

Determination section 220 acquires, based on the image management information in image management information DB 140, which imaging apparatus has imaged the image for which the inputted dynamic analysis processing request is to be executed (step S1102).

Determination section 220 acquires, from quality control information DB 150, quality control information indicating whether each imaging apparatus can obtain an image with a quality necessary for performing dynamic analysis processing (step S1103). The quality control information may be acquired from a cloud. Determination section 220 may store quality control information acquired in advance.

Determination section 220 determines, based on the imaging apparatus that has imaged the image for which the dynamic analysis processing request is to be executed as determined in step S1102 and the quality control information acquired in step S1103, whether the dynamic analysis processing is executable on the image for which the dynamic analysis processing request is to be executed (step S1104).

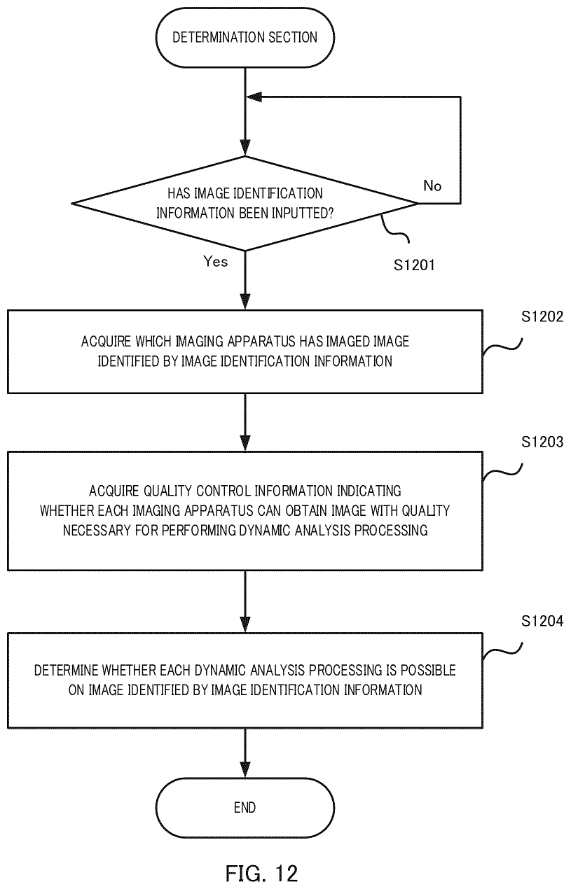

FIG. 12 is a diagram illustrating a flowchart of another process performed by determination section 220.

Determination section 220 determines whether information for identifying an image has been inputted (step S1201). The information for identifying an image may be an image management number or may be a patient and imaging date and time. The information for identifying an image may be an image management number, a patient, and imaging date and time. The information for identifying an image may be information that allows an image to be identified uniquely. The information for identifying an image may be, for example, “latest imaging of patient A”.

In a case where information for identifying an image has not been inputted, determination section 220 causes the flow to return to step S1201 and waits for an input of information for identifying an image.

Determination section 220 acquires, based on the image management information in image management information DB 140, which imaging apparatus has imaged the image identified by the information for identifying the image (step S1202).

Determination section 220 acquires, from quality control information DB 150, quality control information indicating whether each imaging apparatus can obtain an image with a quality necessary for performing dynamic analysis processing (step S1203). The quality control information may be acquired from a cloud. Determination section 220 may store the quality control information acquired in advance.

Determination section 220 determines, based on the imaging apparatus that has imaged the image as determined in step S1202 and the quality control information acquired in step S1203, whether each dynamic analysis processing is executable on the image identified by the information for identifying the image (step S1204).

### <Hardware Configuration>

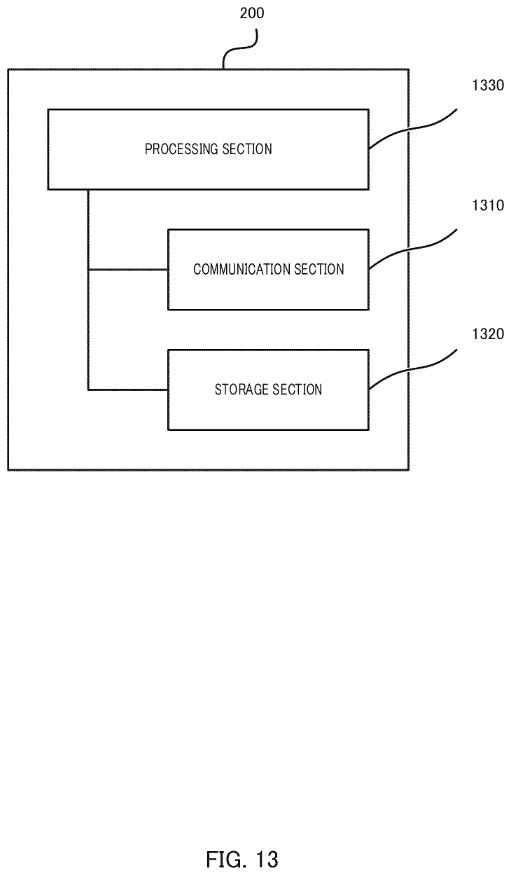

FIG. 13 is a diagram illustrating a hardware configuration of management apparatus 200. Management apparatus 200 includes communication section 1310, storage section 1320, and processing section 1330.

Communication section 1310 communicates input/output data with input/output section 110. Communication section 1310 may receive an image, image management information, and quality control information from image DB 130, image management information DB 140, and quality control information DB 150. For the communication of communication section 1310, any communication means such as a local area network (LAN), a small computer system interface (SCSI), a universal serial bus (USB), Bluetooth, or the Internet can be used.

Storage section 1320 stores a program to be processed by processing section 1330. Storage section 1320 may store an image(s) stored in image DB 130. Storage section 1320 may store the image management information stored in image management information DB 140. Storage section 1320 may store the quality control information stored in quality control information DB 150. The storage section is a storage means such as an HDD or an SSD.

Processing section 1330 may be, for example, a computer such as a CPU. Processing section 1330 is connected to communication section 1310 and storage section 1320, and controls management apparatus 200 in its entirety.

Although an embodiment has been described above with reference to the drawings, the present disclosure is not limited to such an example. It is obvious that a person skilled in the art can conceive of various change examples or modification examples within the scope described in the claims. It is to be understood that such changes or modifications also belong to the technical scope of the present disclosure. Furthermore, the constituent elements in the embodiment may be combined as appropriate without departing from the spirit of the present disclosure.
(1) A management apparatus according to an embodiment of the present disclosure includes: an image DB in which an image is stored; an image management information DB in which an imaging apparatus having imaged each of a plurality of the images is recorded; quality control information DB which stores whether imaging for the imaging apparatus to perform dynamic analysis processing is possible; and a hardware processor that determines whether the dynamic analysis processing is executable on the plurality of images stored in the image DB.
(2) In the management apparatus according to an embodiment of the present disclosure, the management apparatus of (1) further includes an inputter/outputter to which a dynamic analysis processing request for each of the plurality of images is inputted and which outputs a determination result of the hardware processor.
(3) In the management apparatus according to an embodiment of the present disclosure, in the management apparatus of (2), the dynamic analysis processing request includes one image among the plurality of images, where the one image is an image on which the dynamic analysis processing is executed, and a type of the dynamic analysis processing to be executed.
(4) In the management apparatus according to an embodiment of the present disclosure, in the management apparatus of (3), the inputter/outputter outputs whether the dynamic analysis processing is performable in response to the dynamic analysis processing request having been inputted.
(5) In the management apparatus according to an embodiment of the present disclosure, the management apparatus of (1) further includes an inputter/outputter to which information for identifying each of the plurality of images is inputted and which outputs whether each of a plurality of pieces of the dynamic analysis processing is executable on the each of the plurality of images, where the each of the plurality of images has been identified by the inputted information for identifying the each of the plurality of images.
(6) In the management apparatus according to an embodiment of the present disclosure, the management apparatus of (1) further includes an inputter/outputter to which information for identifying a patient is inputted and which outputs whether each of a plurality of pieces of the dynamic analysis processing is executable on each image of the patient, where the each image has been inputted.
(7) In the management apparatus according to an embodiment of the present disclosure, in the management apparatus of (1), in a case where the hardware processor determines that the dynamic analysis processing is impossible, the hardware processor requests new dynamic imaging.
(8) A radiology information system according to an embodiment of the present disclosure includes the management apparatus of (1).
(9) A dynamic analysis apparatus in an embodiment of the present disclosure includes the management apparatus of (1).
(10) A management method according to an embodiment of the present disclosure determines whether dynamic analysis processing is executable on an image having been inputted, based on: information for identifying the image; image management information in which an imaging apparatus having imaged each of a plurality of the images is recorded; and quality control information that stores whether imaging for the imaging apparatus to perform the dynamic analysis processing is possible.
(11) A non-transitory computer-readable recording medium storing a program according to an embodiment of the present disclosure causes a computer to execute: acquiring information for identifying an image; acquiring which imaging apparatus has imaged the image identified by the information for identifying the image, where the imaging apparatus is an imaging apparatus or one of a plurality of imaging apparatuses; acquiring quality control information that indicates whether the imaging apparatus or each of the plurality of imaging apparatuses is capable of obtaining an image with a quality necessary for performing dynamic analysis processing; and determining whether each of a plurality of pieces of the dynamic analysis processing is possible on the image identified by the information for identifying the image.
(12) A management system according to an embodiment of the present disclosure stores whether imaging for an imaging apparatus or each of a plurality of imaging apparatuses to perform dynamic analysis processing is possible, identifies an image that is stored, identifies the imaging apparatus or one of the plurality of imaging apparatuses that has imaged each of a plurality of the images, and determines whether the dynamic analysis processing is executable on the plurality of images having been stored.

### INDUSTRIAL APPLICABILITY

The present disclosure is useful for management in dynamic analysis processing using radiation.

Although embodiments of the present invention have been described and illustrated in detail, the disclosed embodiments are made for purpose of illustration and example only and not limitation. The scope of the present invention should be interpreted by terms of the appended claims.

What is claimed is:

1. A management apparatus, comprising:
an image DB in which an image is stored;
an image management information DB in which an imaging apparatus is recorded, the imaging apparatus having imaged each of a plurality of the images; and
a hardware processor that determines, based on quality control information, whether dynamic analysis processing is executable on the plurality of images stored in the image DB, the quality control information storing whether imaging for the imaging apparatus to perform the dynamic analysis processing is possible.

2. The management apparatus according to claim 1, further comprising an inputter/outputter to which a dynamic analysis processing request for each of the plurality of images is inputted and which outputs a determination result of the hardware processor.

3. The management apparatus according to claim 2, wherein
the dynamic analysis processing request includes one image among the plurality of images and a type of the dynamic analysis processing to be executed, the one image being an image on which the dynamic analysis processing is executed.

4. The management apparatus according to claim 3, wherein
the inputter/outputter outputs whether the dynamic analysis processing is performable in response to the dynamic analysis processing request having been inputted.

5. The management apparatus according to claim 1, further comprising an inputter/outputter to which information for identifying each of the plurality of images is inputted and which outputs whether each of a plurality of pieces of the dynamic analysis processing is executable on the each of the plurality of images, the each of the plurality of images having been identified by the inputted information for identifying the each of the plurality of images.

6. The management apparatus according to claim 1, further comprising an inputter/outputter to which information for identifying a patient is inputted and which outputs whether each of a plurality of pieces of the dynamic analysis processing is executable on each image of the patient, the each image having been inputted.

7. The management apparatus according to claim 1, wherein
in a case where the hardware processor determines that the dynamic analysis processing is impossible, the hardware processor requests new dynamic imaging.

8. A radiology information system, comprising the management apparatus according to claim 1.

9. A dynamic analysis apparatus, comprising the management apparatus according to claim 1.

10. A management method, which determines whether dynamic analysis processing is executable on an image having been inputted, based on:
information for identifying the image;
image management information in which an imaging apparatus is recorded, the imaging apparatus having imaged each of a plurality of the images; and
quality control information that stores whether imaging for the imaging apparatus to perform the dynamic analysis processing is possible.

11. A management system, wherein:
the management system stores whether imaging for an imaging apparatus or each of a plurality of imaging apparatuses to perform dynamic analysis processing is possible,
the management system identifies an image that is stored,
the management system identifies the imaging apparatus or one of the plurality of imaging apparatuses that has imaged each of a plurality of the images, and
the management system determines whether the dynamic analysis processing is executable on the plurality of images having been stored.
